(19) United States
(12) Patent Application Publication
(10) Pub. No.: US 2008/0275817 A1
(43) Pub. Date: Nov. 6, 2008

(54) METHOD AND APPARATUS FOR ENCOURAGING THE FORMATION AND JOINING OF ONLINE ACCOUNT GROUPS

(76) Inventor: German Scipioni, San Jose, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/743,527

(22) Filed: May 2, 2007

(51) Int. Cl. G06Q 40/00

(52) U.S. Cl. 705/42

(57) ABSTRACT

Formation of grouped online monetary accounts. Accounts can be grouped together, and higher interest rates can be offered to each account within the group, based on the total of the account balances of the group. More specifically, individual accounts within the group are not pooled—they remain separate accounts. However, the interest rate applied to the separate accounts is determined according to the total value of the accounts within the group. Groups with larger total assets are offered higher interest rates, which encourages account owners to join groups so as to take advantage of these higher rates. In some embodiments, group owners are given control over who is invited to join their group.

### BRIEF DESCRIPTION OF THE INVENTION

This invention relates generally to electronic commerce. More specifically, this invention relates to methods and apparatuses for encouraging the formation and joining of online account groups.

### BACKGROUND OF THE INVENTION

The rapid growth of electronic commerce has led to the rise of many associated services, such as online monetary accounts. These accounts serve as repositories of funds that account owners can access and use via commonly available computer networks such as the Internet. Such computer-accessible accounts have the advantage of helping account owners conduct online purchases quickly and easily.

However, despite their ability to facilitate electronic commerce, improvements in online monetary accounts are desired. In particular, it would be beneficial to be able to utilize such accounts as a tool to help solve other problems surrounding e-commerce. For example, it is desirable to utilize online accounts in ways that reduce problems such as e-commerce fraud, and the cost of customer support. In addition, it is often desirable to use online accounts as a mechanism or vehicle for bringing account owners together in ways that allow them to discuss and resolve common account-related issues.

Accordingly, continuing efforts exist to expand upon the uses for, and benefits of, online monetary accounts.

### SUMMARY OF THE INVENTION

The invention can be implemented in numerous ways, including as a method and as a computer-readable medium. Various embodiments of the invention are discussed below.

In one embodiment, a method of forming grouped online monetary accounts comprises establishing a plurality of monetary accounts, wherein each monetary account of the plurality of monetary accounts is an online monetary account that is computer accessible by an owner of the monetary account. Monetary accounts of the plurality of monetary accounts are grouped so as to form an account group, the account group having a total value that is the sum of the account balances of the monetary accounts within the account group. An interest rate is determined according to the total value of the account balances, and the interest rate is applied to each monetary account of the account group.

In another embodiment, a method of encouraging the formation of groups of online monetary accounts comprises offering to join a monetary account to a group of monetary accounts, and offering an interest rate to every monetary account within the group of monetary accounts. The interest rate is a progressive interest rate having a magnitude that generally increases according to a sum of the account balances of the monetary accounts within the group of monetary accounts. Each monetary account of the group of monetary accounts is an online monetary account that is computer accessible by an owner of the monetary account.

In another embodiment, a computer-readable medium has computer-executable instructions thereon for executing a method of forming grouped online monetary accounts, the method comprising establishing a plurality of monetary accounts, wherein each monetary account of the plurality of monetary accounts is an online monetary account that is computer accessible by an owner of the monetary account. The monetary accounts of the plurality of monetary accounts are grouped so as to form an account group, the account group having a total value that is the sum of the account balances of the monetary accounts within the account group. An interest rate is determined according to the total value of the account balances, and is applied to each monetary account of the account group.

Other aspects and advantages of the invention will become apparent from the following detailed description taken in conjunction with the accompanying drawings which illustrate, by way of example, the principles of the invention.

### BRIEF DESCRIPTION OF THE DRAWINGS

For a better understanding of the invention, reference should be made to the following detailed description taken in conjunction with the accompanying drawings, in which:

FIG. 1 illustrates an exemplary computer system for implementing embodiments of the present invention.

FIG. 2 illustrates details of an exemplary account group server for use in the computer system of FIG. 1.

FIG. 3 illustrates steps commonly employed in the operation of the system of FIGS. 1-2.

Like reference numerals refer to corresponding parts throughout the drawings.

### DETAILED DESCRIPTION OF EMBODIMENTS OF THE INVENTION

In one sense, the invention relates to the formation of grouped online monetary accounts. Accounts can be grouped together, and higher interest rates can be offered to each account within the group, based on the total of the account balances of the group. More specifically, individual accounts within the group are not pooled—they remain separate accounts. However, the interest rate applied to the separate accounts is determined according to the total value of the accounts within the group. Groups with larger total assets are offered higher interest rates, which encourages account owners to join groups so as to take advantage of these higher rates. In some embodiments, group owners are given control over who is invited to join their group.

Institutions that offer higher interest rates to those who join their groups are more attractive to potential customers, as account owners are given a monetary incentive to open an account with those institutions and join their groups. In addition, the formation of online account groups confers further advantages. For example, groups can have their own message board or other communications medium, allowing group members to communicate with each other. This gives account owners an “online community” of fellow group members with which they can interact. In particular, group members within an online community often face similar issues related to e-commerce, and can turn to each other for support or to answer questions. This in turn can reduce customer support costs to various e-commerce applications. In addition, the existence of such communities may help reduce fraud and other related e-commerce problems. In particular, given a sense of community, group members may have a tendency to invite those who they deem more trustworthy, leading to relatively more online account owners who do not engage in fraudulent e-commerce activities. Thus, embodiments of the invention may help reduce fraud by encouraging an increasing number of “honest” e-commerce participants, and fewer participants who are inclined to participate in fraudulent activities.

FIG. 1 illustrates an exemplary computer system for implementing embodiments of the present invention. Here, a computer system 10 includes an account group server 20 for grouping accounts and administering the grouped accounts according to embodiments of the invention. The system 10 also includes any number of user computers 30-40, and at least one financial institution server 50 that maintains individual accounts placed with that institution. These various parts are typically in communication with each other through computer network 60, which can be any known computer network such as the Internet.

The account group server 20 administers and maintains the account group, allowing owners of these accounts to access them via their user computers 30-40. The account group server 20 and/or user computers 30-40 are also in communication with the financial institution server 50. Account owners can thus access the account group server 20 via their user computers 30-40, and communicate with other group members or access their accounts.

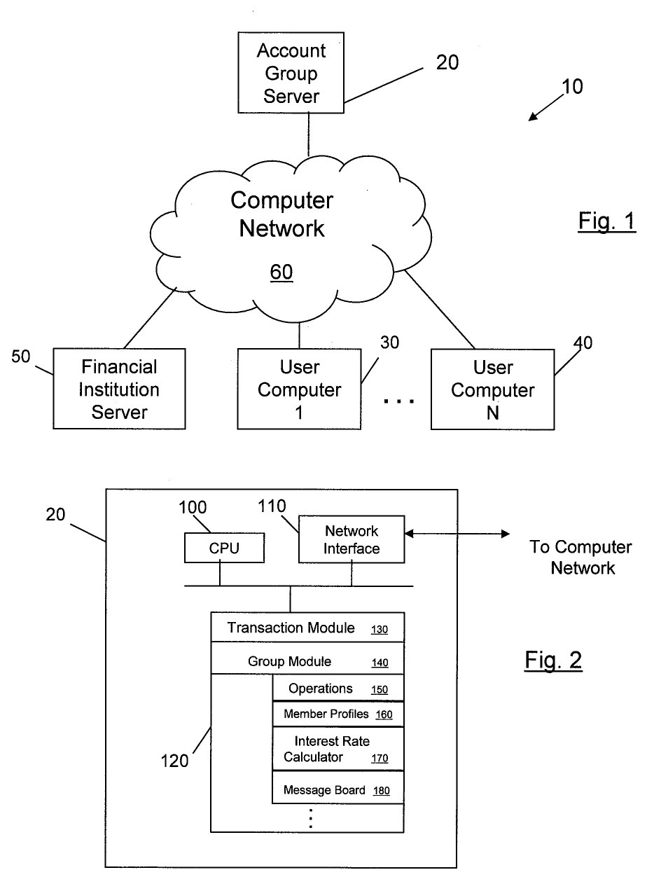

FIG. 2 illustrates further details of the account group server 20. The server 20 includes a central processing unit (CPU) 100 controlling its operation, a network interface 110 for communicating with external devices such as computer network 60, and a memory 120. The memory 120 stores a number of computer program modules designed to carry out specified tasks. These include a transaction module 130 for conducting account transactions, and a group module 140 for each account group. The group module 140 can be configured to handle a single group, in which case multiple such group modules 140 would exist in the memory 120. Alternatively, the group module 140 can be configured to handle multiple account groups. Each group module 140 includes various sub-modules, such as an operations sub-module 150 governing the operation of any group features and functions, a database of member profiles 160 that contains user information required by the operations sub-module 150, an interest rate calculator 170 for determining the interest rate applied to each account in the group, and message board software 180 for running a group message board.

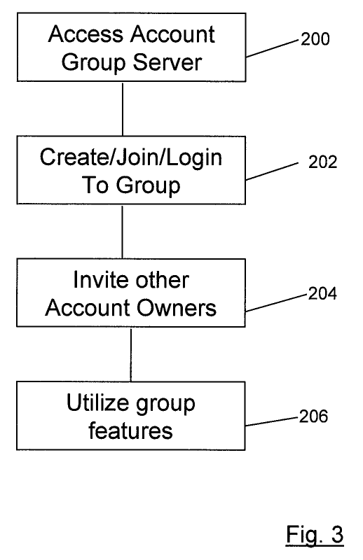

FIG. 3 illustrates steps employed in the operation of the system of FIGS. 1-2, i.e., the creation and operation of account groups. Users begin by accessing the account group server 20 via their user computers 30-40 (step 200). Access can be for the purpose of opening a new account, in which case the account group server 20 and/or user computer 30-40 must also access the financial institution server 50 of the institution at which the new account is to be opened. The verification of the user's identity and transfer of funds can then occur in known fashion. Step 200 may also be performed for the purpose of accessing an existing account, in which case the user typically must verify their identity, again in known fashion (e.g., by password, etc.). Once a user has accessed his account, he/she is free to utilize its funds in any manner supported by the account group server 20. For example, he/she may conduct online transactions through various applications that may be run on the server 20, or through other application servers accessible through computer network 60.

Once access to the server 20 is granted, users can access their account group (step 202), either by creating a new account group, joining an account group they have been invited to, or by logging into a group to which they already belong. As above, logins can be accomplished in known fashion.

Once in the account group, members can also send invitations to other account owners (step 204) to join. This can be done in many ways, including by search of existing account owners, or by foreknowledge of account owners already known. Allowing account groups to grow by invitation permits groups to invite only those they know and trust, thus likely reducing the possibility of fraud or the number unreliable account holders. Alternatively, it is sometimes desirable to prevent account owners from inviting others, and allow only an account administrator (such as the founder of the account group, or the financial institution) to issue invitations. This would allow an additional measure of control over group membership, if desired. Once a user, financial institution, or any other body sends an invitation, it may be received at the account group server 20, at which point the server 20 notifies the user when he/she logs in. The invitation may also be directed to the appropriate user computer 30-40 or some other destination, such as the user's email server.

Once in the account group, members can utilize their accounts in typical fashion, such as by conducting electronic transactions. It should be reiterated here that group members essentially help each other to take advantage of better interest rates and, in some embodiments, can communicate with each other, yet each group member's account remains a separate and independent account. Thus, while a group is linked for purposes of interest rate determination, and may have a single administrator or super user who controls group invitations, group members do not see each others' financial information, and do not have access to funds from others' accounts.

Members can also utilize other features of the account group (step 206). While the invention contemplates a wide range of features directed to improving the capabilities of online account holders, three such features are discussed in further detail below.

The first such feature is the improved interest rate offered to group members. As above, the interest rate is determined according to a progressive scale that encourages the formation of account groups, and the joining of accounts to those groups. As groups grow, they become eligible for better interest rates.

In operation, the interest rate calculator 170 determines the appropriate interest rate, and applies it to each account in the group. While the invention contemplates any interest rate schedule designed to encourage the joining of account groups, one embodiment of the invention can employ a progressive interest rate table offering higher interest rates at various predetermined values of total group assets. For example, an annual rate of 2% can be offered if the total of all accounts in the group is above $100,000, with 2.25% offered if the total is above $500,000. The invention includes any such progressive rate table offering any interest rate values at any levels of total group assets. Similarly, the invention includes progressive rate tables with rates based on other metrics besides total group assets. For instance, interest rates offered can be based on average value of the accounts in the group. The invention includes use of any known metric.

The second feature is a communications medium allowing group members to communicate with each other. Any suitable communications medium is contemplated. For example, the account group server 20 can utilize message board software 180 to support a message board that group members can post to. Other embodiments of the communications medium include Instant Messaging (IM) or chat services allowing group members to communicate with each other via IM or chat windows, or simply the posting of other contact information such as the electronic mail addresses or phone numbers of group members. This allows group members to contact each other for any questions they may have. This allows group members to turn to each other first, reducing their reliance on companies' customer service lines, in turn reducing the burden and expense to companies that maintain these lines.

The third feature concerns the ability to provide incentives encouraging desirable behavior. For example, it may be desirable to encourage account owners to conduct a large number of online transactions, or avoid fraud or other undesirable behavior. In these cases, incentives encouraging transactions or discouraging bad behavior can be offered to all members of a group. For instance, financial institutions or others can offer further increases to individual account interest rates, cash back on debit cards, or the like, after that account participates in a threshold number of online transactions or refrains from undesirable behavior for a specified amount of time. The invention is not limited to these specific examples, and contemplates any mechanism that can be offered to an account group for encouraging the behavior of group members in any particular manner.

In some embodiments, it may be desirable to implement limits on account groups. For instance, limits on the total number of accounts may be imposed, so as to prevent groups from becoming too large, difficult to administer, or perhaps ruining a sense of community. Alternatively, limits may be placed on total group assets. The invention contemplates any such limits, and any numerical value for any limit.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. Many modifications and variations are possible in view of the above teachings. For example, the invention can include any form of progressively-increasing interest rate schedule. The embodiments were chosen and described in order to best explain the principles of the invention and its practical applications, to thereby enable others skilled in the art to best utilize the invention and various embodiments with various modifications as are suited to the particular use contemplated.

1. A method of forming grouped online monetary accounts, comprising:
establishing a plurality of monetary accounts, wherein each monetary account of the plurality of monetary accounts is an online monetary account that is computer accessible by an owner of the monetary account;
grouping monetary accounts of the plurality of monetary accounts so as to form an account group, the account group having a total value that is the sum of the account balances of the monetary accounts within the account group;
determining an interest rate according to the total value of the account balances; and applying the interest rate to each monetary account of the account group.

2. The method of claim 1 wherein the interest rate is a progressive interest rate that generally increases as the total value increases.

3. The method of claim 2 wherein the interest rate increases when the total value exceeds a predetermined value.

4. The method of claim 1 further comprising establishing a communications medium facilitating communication among owners of the monetary accounts within the account group.

5. The method of claim 1 further comprising preventing a joining of further monetary accounts to the account group if the number of monetary accounts within the account group exceeds a predetermined number.

6. The method of claim 1 further comprising preventing the joining of further monetary accounts to the account group if the total value exceeds a predetermined value.

7. The method of claim 1 further comprising:
receiving a request from an owner of a monetary account to join the account group; and
joining a monetary account to the account group in response to the request.

8. The method of claim 1 further comprising providing a financial incentive to each monetary account of the plurality of monetary accounts, the financial incentive encouraging participation in online transactions.

9. A method of encouraging the formation of groups of online monetary accounts, the method comprising:
offering to join a monetary account to a group of monetary accounts; and
offering an interest rate to every monetary account within the group of monetary accounts;
wherein the interest rate is a progressive interest rate having a magnitude that generally increases according to a sum of the account balances of the monetary accounts within the group of monetary accounts; and
wherein each monetary account of the group of monetary accounts is an online monetary account that is computer accessible by an owner of the monetary account.

10. The method of claim 9 wherein the interest rate increases when the sum of the account balances exceeds a predetermined value.

11. The method of claim 9 further comprising establishing a communications medium facilitating communication among owners of the monetary accounts within the group of monetary accounts.

12. The method of claim 9 further comprising preventing a joining of further monetary accounts to the group of monetary accounts if the number of monetary accounts within the group of monetary accounts exceeds a predetermined number.

13. The method of claim 9 further comprising preventing the joining of further monetary accounts to the group of monetary accounts if the sum of the account balances exceeds a predetermined value.

14. The method of claim 9 further comprising:
receiving a request from an owner of a monetary account to join the group of monetary accounts; and
joining a monetary account to the group of monetary accounts in response to the request.

15. The method of claim 9 further comprising providing a financial incentive to each monetary account of the group of monetary accounts, the financial incentive encouraging participation in online transactions.

16. A computer-readable medium having computer-executable instructions thereon for executing a method of forming grouped online monetary accounts, the method comprising:
establishing a plurality of monetary accounts, wherein each monetary account of the plurality of monetary accounts is an online monetary account that is computer accessible by an owner of the monetary account;
grouping monetary accounts of the plurality of monetary accounts so as to form an account group, the account group having a total value that is the sum of the account balances of the monetary accounts within the account group;
determining an interest rate according to the total value of the account balances; and
applying the interest rate to each monetary account of the account group.

17. The computer-readable medium of claim 16 wherein the interest rate is a progressive interest rate that generally increases as the total value increases.

18. The method of claim 17 wherein the interest rate increases when the total value exceeds a predetermined value.

19. The computer-readable medium of claim 16 wherein the method further comprises establishing a communications medium facilitating communication among owners of the monetary accounts within the account group.

20. The computer-readable medium of claim 16 wherein the method further comprises preventing a joining of further monetary accounts to the account group if the number of monetary accounts within the account group exceeds a predetermined number.

21. The computer-readable medium of claim 16 wherein the method further comprises preventing the joining of further monetary accounts to the account group if the total value exceeds a predetermined value.

22. The computer-readable medium of claim 16 wherein the method further comprises:
receiving a request from an owner of a monetary account to join the account group; and
joining a monetary account to the account group in response to the request.

23. The computer-readable medium of claim 16 wherein the method further comprises providing a financial incentive to each monetary account of the plurality of monetary accounts, the financial incentive encouraging participation in online transactions.
